(19) United States
(12) Patent Application Publication
(10) Pub. No.: US 2002/0160261 A1
(43) Pub. Date: Oct. 31, 2002

(54) Borate salts for use in electrochemical cells

(75) Inventors: Michael Schmidt, Seeheim-Jugenheim (DE); Andreas Kuhner, Darmstadt (DE); Klaus-Dieter Franz, Kelkheim (DE); Gerd-Volker Roschenthaler, Bremen (DE); German Bissky, Bremen (DE); Alexander Kolomeitsev, Kiew (UA); Alexander Kadyrov, Moskau (RU)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck GmbH, Darmstadt (DE)

(21) Appl. No.: 10/053,874

(22) Filed: Jan. 24, 2002

(30) Foreign Application Priority Data
Jan. 24, 2001 (DE) 10103189.0

(51) Int. Cl. C07F 5/02; H01M 10/40

(52) U.S. Cl. 429/188; 568/6; 429/189; 568/3

(57) ABSTRACT

The invention relates to borate salts and to their use in electro-chemical cells.

The invention relates to borate salts, to a process for their preparation, and to their use in electrochemical cells.

Lithium ion batteries are amongst the most promising systems for mobile applications. The areas of application extend from high-quality electronic equipment (for example mobile telephones, camcorders) to batteries for electrically driven motor vehicles.

These batteries comprise a cathode, an anode, a separator and a non-aqueous electrolyte. The cathode is typically Li(MnMe_{z},)₂O₄Li(CoMe_{z})O₂, Li(CoNiₓMe_{z})O₂ or other lithium intercalation and insertion compounds. Anodes can consist of lithium metal, soft and hard carbons, graphite, graphitic carbons or other lithium intercalation and insertion compounds or alloy compounds. As electrolyte, use is made of solutions containing lithium salts, such as LiPF₆, LiBF₄, LiClO₄, LiAsF₆, LiCF₃SO₃, LiN(CF₃SO₂)₂ or LiC(CF₃SO₂)₃ and mixtures thereof in aprotic solvents.

The customary lithium conductive salts reveal various disadvantages. Some conductive salts have low cycling yields (for example LiBF₄). Other conductive salts have low thermal stability (for example LiPF₆), and still other conductive salts are not particularly suitable owing to their toxicity and low environmental friendliness (for example LiAsF₆).

LiBF₄ would have higher thermal stability than LiPF₆. However, it forms electrolytes with very low ionic conductivity in aprotic solvents and is thus not very suitable for high-energy batteries.

In order to avoid these disadvantages, alternative lithium salts have been proposed.

For example, imides, in particular bis(trifluoromethylsulfonyl)imide in accordance with U.S. Pat. No. 45,054,997, and methanides, in particular tris(trifluoromethylsulfonyl)methanide in accordance with U.S. Pat. No. 5,273,840, have been proposed. These salts have high anodic stability and are able to form solutions of high conductivity in organic aprotic solvents.

However, aluminum, which is usually employed as cathodic current collector, is not passivated to an adequate extent, at least by imides (L. A. Dominey, Current State of Art on Lithium Battery Electrolyte in G. Pistoia (Ed.) Lithium Batteries, Amsterdam, Elsevier, 1994).

By contrast, methanides can only be prepared and purified at very great expense. In addition, the electrochemical properties, such as oxidation stability and passivation of aluminum, are very highly dependent on the purity of the methanide (WO 99/07676).

As further alternatives, EP 0698301 has proposed lithium spiroborates and Electrochemical and Solid State Letters, 2(2) 60-62 (1999) has proposed lithium spirophosphates. Owing to the use of bidentate ligands, these salts have high thermal decomposition points of in some cases above 200° C. With oxidation potentials of at most 4.3 V against Li/Li⁺, however, the electrochemical stability is not adequate for use in lithium batteries with highly oxidising electrode materials, such as, for example, LiMn₂O₄ or LiCo₁₋ₓNiₓO₂ (0<x<1).

EP 929558 teaches the use of lithium fluoroalkylphosphates, preferably having perfluorinated ethyl or isopropyl groups. The thermal stability and the hydrolysis resistance of these lithium salts is significantly increased compared with LiPF₆.

An object of the present invention is to provide salts for electrolytes for use in electrochemical cells of high conductivity which are electrochemically stable.

These and other objects according to the invention are achieved by borate salts of the general formula

Mⁿ⁺[BFₓ(C_{y}F_{2y+1-z}H_{z})₄₋ₓ]ₙ⁻ (I)

in which:

1<x<3, 1 ≦y≦8 and 0≦z≦2y+1 and

M is a monovalent to trivalent cation (1≦n≦3), apart from potassium and barium,

in particular:

Li,

NR¹R²R³R⁴, PR⁵R⁶R⁷R⁸, P(NR⁵R⁶)ₖR⁷ₘR⁸ ₄₋ₖ₋ₘ(where k=1-4,m=0-3 and k+m≦4) or

C(NR⁵R⁶)(NR⁷R⁸)(NR⁹R¹⁰), where

R¹ to R⁴ are C_{y}F_{2y+1-z}H_{z} and

R⁵ to R¹⁰ are H or

C_{y}F_{2y+1-z}H_{z},

or an aromatic heterocyclic cation, in particular nitrogen- and/or oxygen- and/or sulfur-containing aromatic heterocyclic cations.

Upon further study of the specification and appended claims, further objects and advantages of this invention will become apparent to those skilled in the art.

The invention relates to a process for the preparation of these compounds and to their use in electrolytes for electrochemical cells, batteries, double layer capacitors and supercapacitors.

It has been found that, due to the asymmetrical structure of the anions, the solubility of the salts according to the invention in aprotic solvents is significantly higher than that of LiBF₄, Li[BF₃(CF₃)] and Li[BF₃(CH₃)], for example, the solubility in pure diethylene carbonate

is significantly above 2.5 mol/l. Surprisingly, it has been found that the salts according to the invention have significantly higher conductivities in typical solvent mixtures for electrochemical cells, for example, EC/DEC, compared with LiBF₄. For Li[BF₃(CF₃)] in EC/DEC, conductivity values close to those of LiPF₆ have been found.

It has also been found that the salts have very good hydrolysis stability. Thus, for example, the synthesis of Li[BF₃(CF₃)] succeeds from an aqueous medium.

In addition, the salts according to the invention exhibit an electro-chemical stability comparable with that of LiPF₆.

The borate salts prepared in accordance with the invention are thus particularly suitable for use in electrochemical cells. The borate salts can be used with other lithium salts or alternatively with borate complexes in electrolytes for secondary lithium batteries.

The borate salts can also be employed in electrolytes comprising conventional conductive salts. Examples of suitable electrolytes are those comprising conductive salts selected from the group consisting of LiPF₆, LiBF₄, LiClO₄, LiAsF₆, LiCF₃SO₃, LiN(CF₃SO₂)₂ and LiC(CF₃SO₂)₃, and mixtures thereof. The electrolytes may also comprise organic isocyanates (DE 199 44 603) for reducing the water content. The electrolytes may also comprise organic alkali metal salts (DE 199 10 968) as additive. Suitable are alkali metal borates of the general formula

Li⁺B⁻(OR¹)ₘ(OR²)ₚ

in which

m and p are 0, 1, 2, 3 or 4, where m+p=4, and R¹ and R² are identical or different,

are optionally bonded directly to one another via a single or double bond,

are each, individually or together, an aromatic or aliphatic carboxylic, dicarboxylic or sulfonic acid radical, or

are each, individually or together, an aromatic ring from the group consisting of phenyl, naphthyl, anthracenyl and phenanthrenyl, which may be unsubstituted or mono- to tetrasubstituted by A or Hal, or

are each, individually or together, a heterocyclic aromatic ring from the group consisting of pyridyl, pyrazyl and bipyridyl, which may be unsubstituted or mono- to trisubstituted by A or Hal, or

are each, individually or together, an aromatic hydroxy acid from the group consisting of aromatic hydroxycarboxylic acids and aromatic hydroxysulfonic acids, which may be unsubstituted or mono- to tetrasubstituted by A or Hal,

and

Hal is F, Cl or Br

and

A is alkyl having 1 to 6 carbon atoms, which may be mono- to trihalogenated.

Also suitable as electrolytes are alkali metal alkoxides of the general formula

Li⁺OR⁻

in which R is an aromatic or aliphatic carboxylic, dicarboxylic or sulfonic acid radical, or

is an aromatic ring from the group consisting of phenyl, naphthyl, anthracenyl and phenanthrenyl, which may be unsubstituted or mono- or tetrasubstituted by A or Hal, or

is a heterocyclic aromatic ring from the group consisting of pyridyl, pyrazyl and bipyridyl, which may be unsubstituted or mono- to trisubstituted by A or Hal, or

is an aromatic hydroxy acid from the group consisting of aromatic hydroxycarboxylic acids and aromatic hydroxysulfonic acids, which may be unsubstituted or mono- to tetrasubstituted by A or Hal,

and

Hal is F, Cl or Br

and

A is alkyl having 1 to 6 carbon atoms, which may be mono- to trihalogenated.

The electrolytes may comprise compounds of the following formula (DE 199 41 566):

[([R¹(CR²R³)ₖ]ₗAₓ)_{y}Kt]⁺⁻N(CF₃)₂

where

Kt is N, P, As, Sb, S or Se, or a heterocyclic ring comprising N, P, As, Sb, S or Se in the ring,

A is N, P, P(O), O, S, S(O), SO₂, As, As(O), Sb or Sb(O) R¹, R² and R³ are identical or different

and are H, halogen, substituted and/or unsubstituted alkyl CₙH₂ₙ₊₁, substituted and/or unsubstituted alkenyl having 1-18 carbon atoms and one or more double bonds, substituted and/or unsubstituted alkynyl having 1-18 carbon atoms and one or more triple bonds, substituted and/or unsubstituted cycloalkyl CₘH₂ₘ₋₁, mono- or polysubstituted and/or unsubstituted phenyl, or substituted and/or unsubstituted heteroaryl,

A can be included in R¹, R² and/or R³ in any position, in the chain,

the groups bonded to Kt may be identical or different,

n=1-18

m=3-7

k=0 or 1-6

l=1 or 2 in the case where x=1 and 1 in the case where x=0

x=0 or 1

y=1-4.

A process for the preparation of these compounds comprises reacting an alkali metal salt of the general formula

D⁺⁻N(CF₃)₂ (II)

where D⁺ is an alkali metal,

with a salt of the general formula (III) in a polar organic solvent

[([R¹(CR²R³)ₖ]ₗAₓ)_{y}Kt]⁺⁻E (III)

where

Kt, A, R¹, R², R³, k, l, x and y are as defined above, and ⁻E is F⁻, Cl⁻, Br⁻, l⁻, BF₄⁻, ClO₄⁻, AsF₆⁻, SbF₆⁻ or PF₆⁻.

However, use can also be made of electrolytes comprising compounds of the general formula (DE 199 53 638)

X—(CYZ)ₘ—SO₂N(CR¹R²R³)₂

where

X is H, F, Cl, CₙF₂ₙ₊₁, CₙF₂ₙ₋₁ or (SO₂)ₖN(CR¹R²R³)₂

Y is H, F or Cl

Z is H, F or Cl

R¹, R² and R³ are, each independently, H, alkyl, fluoroalkyl or cycloalkyl

m is 0-9 and, if X=H, m≠0

n is 1-9

k is 0 if m=0 and k=1 if m=1-9,

which can be prepared by reacting partially or perfluorinated alkylsulfonyl fluorides with dimethylamine in organic solvents, and complex salts of the general formula (DE 199 51 804)

M^{x+}[EZ]_{x/y}^{y-}

in which:

x and y are 1, 2, 3, 4, 5 or 6

M^{x+} is a metal ion

E is a Lewis acid selected from the group consisting of

BR¹R²R³, AlR¹R²R³, PR¹R²R³R⁴R⁵, AsR¹R²R³R⁴R⁵ and VR¹R²R³R⁴R⁵,

R¹ to R⁵ are identical or different, are optionally bonded directly to one another via a single or double bond, and each, individually or together, are

a halogen (F, Cl or Br),

an alkyl or alkoxy radical (C₁ to C₈), which may be partially or fully substituted by F, Cl or Br,

an aromatic ring, optionally bonded via oxygen, from the group consisting of phenyl, naphthyl, anthracenyl and phenanthrenyl, which may be unsubstituted or mono- to hexasubstituted by alkyl (C₁ to C₈) or F, Cl or Br,

an aromatic heterocyclic ring, optionally bonded via oxygen, comprising pyridyl, pyrazyl and pyrimidyl which may be unsubstituted or mono- to tetrasubstituted by alkyl (C₁ to C₈) or F, Cl or Br, and

Z is OR⁶, NR⁶R⁷, CR⁶R⁷R⁸, OSO₂R⁶, N(SO₂R⁶)(SO₂R⁷), C(SO₂R⁶)(SO₂R⁷)(SO₂R⁸) or OCOR⁶,

R⁶ to R⁸ are identical or different, are optionally bonded directly to one another via a single or double bond and are each, individually or together,

hydrogen or as defined for R¹ to R⁵,

which can be prepared by reacting a corresponding boron or phosphorus Lewis acid/solvent adduct with a lithium or tetraalkylammonium imide, methanide or triflate.

Borate salts (DE 199 59 722) of the general formula

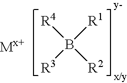

in which:

M is a metal ion or tetraalkylammonium ion, x and y are 1, 2, 3, 4, 5 or 6,

R¹ to R⁴ are identical or different and are alkoxy or carboxyl radicals (C₁-C₈), which are optionally bonded directly to one another via a single or double bond,

may also be present. These borate salts are prepared by reacting lithium tetraalkoxyborate or a 1:1 mixture of lithium alkoxide and a borate with a suitable hydroxyl or carboxyl compound in a ratio of 2:1 or 4:1 in an aprotic solvent.

Additives may also be employed in electrolytes comprising lithium fluoroalkylphosphates of the general formula (I)

Li⁺[PFₓ(C_{y}F_{2y+1-z}H_{z})₆₋ₓ]⁻ (I)

in which

1≦x≦5

3≦y≦8

0≦z≦2y+1

and the ligands (C_{y}F_{2y+1-z}H_{z}) may be identical or different, with the exception of the compounds of the general formula (I′)

Li+[PFₐ(CH_{b}F_{c}(CF₃)_{d})ₑ]⁻ (I′)

in which a is an integer 2 to 5, b=0 or 1, c=0 or 1, d=2 and

e is an integer 1 to 4, with the provisos that b and c are not simultaneously each=0, and the sum a+e is equal to 6, and the ligands (CH_{b}F_{c}(CF₃)_{d}) may be identical or different (DE 100 089 55).

A process for the preparation of lithium fluoroalkylphosphates of the general formula (I) is characterised in that at least one compound of the general formula

HₘP(CₙH₂ₙ₊₁)₃₋ₘ(III),

OP(CₙH₂ₙ₊₁)₃ (IV),

ClₘP(CₙH₂ₙ₊₁)₃₋ₘ (V),

FₘP(CₙH₂ₙ₊₁)₃₋ₘ (VI),

ClₒP(CₙH₂ₙ₊₁)₅₋ₒ (VII),

FₒP(CₙH₂ₙ₊₁)₅₋ₒ (VIII),

in each of which

0≦m≦2, 3≦n≦8 and 0≦o≦4,

is fluorinated by electrolysis in hydrogen fluoride, the resultant mixture of fluorination products is separated by extraction, phase separation and/or distillation, and the resultant fluorinated alkyl-phosphorane is reacted with lithium fluoride in an aprotic solvent mixture with exclusion of moisture, and the resultant salt of the general formula (I) is purified and isolated.

The additives can be used in electrolytes for electrochemical cells containing anode material comprising coated metal cores selected from the group consisting of Sb, Bi, Cd, In, Pb, Ga and tin or alloys thereof (DE 100 16 024). The process for the preparation of this anode material comprises:

a) a suspension or sol of the metal or alloy core in urotropin is prepared,

b) the suspension is emulsified with C₅-C₁₂-hydrocarbons,

c) the emulsion is precipitated onto the metal or alloy cores, and

d) the metal hydroxides or oxyhydroxides are converted into the corresponding oxide by heating the system.

The additives can also be employed in electrolytes for electrochemical cells having cathodes made from lithium intercalation and insertion compounds, and also with cathode materials comprising lithium mixed oxide particles coated with one or more metal oxides (DE 199 22 522) by suspending the particles in an organic solvent, adding a solution of a hydrolysable metal compound and a hydrolysis solution to the suspension, and then filtering off, drying and, if desired, calcining the coated particles. They may also comprise lithium mixed oxide particles which are coated with one or more polymers (DE 199 46 066) which can be obtained by a process in which the particles are suspended in a solvent, and the coated particles are subsequently filtered off, dried and, if desired, calcined. The additives according to the invention may likewise be employed in systems having cathodes comprising lithium mixed oxide particles with one or more coatings of alkali metal compounds and metal oxides (DE 100 14 884). The process for the production of these materials is characterised in that the particles are suspended in an organic solvent, an alkali metal salt compound suspended in an organic solvent is added, metal oxides dissolved in an organic solvent are added, a hydrolysis solution is added to the suspension, and the coated particles are subsequently filtered off, dried and calcined.

A typical example of the invention comprises:

a BF₃/solvent complex is reacted 1:1 with an alkyllithium at temperatures below 0° C. The mixture is slowly warmed to room temperature. Some of the solvent is removed, and the solid is filtered off. The solid is purified.

A further process for the preparation of the salts according to the invention starts from lithium salts, which are reacted 1:1 with [B(CF₃)F₃]⁻ salts known from the literature (lit: Chambers, J. Am. Soc., 82, 5298 (1960)) in a suitable solvent. The mixture is stirred at elevated temperature and subsequently filtered. Aprotic non-aqueous solvents, preferably solvents which are used in electrochemical cells, are added to the reaction mixture, and the mixture is dried.

The borate salt according to the invention can also be obtained by reacting the [B(CF₃)F₃]⁻ salt known from the literature (Chambers, J.Am.Soc, 82, 5298) from 1:1 to 1:1.5 with lithium salts and stirring the mixture in water at elevated temperature. The reaction mixture is heated at the boiling point for from 0.5 to 2 hours, the water is removed, suitable solvents, preferably solvents which are employed in electrochemical cells, are subsequently added, and the mixture is dried.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius; and, unless otherwise indicated, all parts and percentages are by weight.

The entire disclosures of all applications, patents and publications, cited above or below, and of corresponding German application No. 0103189.0, filed Jan. 24, 2001, is hereby incorporated by reference.

### EXAMPLES

### Example 1

### Lithium methyltrifluoroborate

3.1 g of a 5% diethyl ether solution of MeLi (7.1 mmol of MeLi) were slowly added dropwise at −10° C. to 1.0 g (7.1 mmol) of boron tri-fluoride etherate in 5 ml of diethyl ether, and the reaction mixture was warmed to room temperature over the course of 2 hours with stirring. Half of the solvent was removed, and the white solid was filtered off and washed with 1 ml of ether. The ether residues were removed under reduced pressure. Yield: 0.5 g (85%). (¹⁹F NMR:−154.7 (m); ¹H NMR:−1.48 (s))

$$MeLi + {BF}_{3} {OEt}_{2} {\to }^{ {Et}_{2} O } {{Li}^{+} [ {MeBF}_{3} ]}^{-}$$

### Example 2

### Lithium trifluoromethyltrifluoroborate

21.27 g (0.071 mol) of trimethylstannonium trifluoromethyltrifluoroborate were added to 1.84 g (0.071) mol of lithium fluoride in 100 ml of water. The mixture was stirred at 60° C. for 12 hours, then the insoluble trimethylfluorostannane was filtered off, up to 80% of the water was removed, and the trimethylfluorostannane residues were filtered off (10.2 g of Li⁺[B(CF₃)F₃]⁻ were expected). Water was then pumped out until the solution became viscous.

$${Me}_{3} {{Sn}^{+} [ B ( {CF}_{3} ) {F}_{3} ]}^{-} {{\to }^{+ LiF}}_{\begin{matrix}{H}_{2} O \\ - {FSnMe}_{3}\end{matrix}} {{Li}^{+} [ B ( {CF}_{3} ) {F}_{3} ]}^{-}$$

The viscous, water-containing reaction mixture (contaminated with 15% of LiBF₄) was dissolved in 50 ml of diethyl carbonate, dried using magnesium sulfate and filtered, 100 ml of CCl₄ were added, and the mixture was stirred. The precipitated LiBF₄ was filtered off, and the solution was monitored for BF₄ by means of ¹⁹F-NMR spectroscopy. The salt content was checked using a fluorine-containing volatile reference (CF₃-cyclo-C₆F₁₁), and all the CCl₄ was removed under reduced pressure (15 mmHg). The diethyl carbonate removed together with CCl₄ was replenished. The solution was subsequently adjusted to the desired concentration by further pumping-out diethyl carbonate.

¹⁹F-NMR:−76.0 (q, ³J_{BF}=33.6 Hz); −156.0 (q, ¹J_{BF}=40.7 Hz). Data for anions correspond to those from ref. [1, 2].

### Example 3

### Tetraethylammonium trifluoromethyltrifluoroborate

Lithium trifluoromethyltrifluoroborate was reacted with tetraethylammonium chloride in acetonitrile at room temperature to give tetraethylammonium trifluoromethyltrifluoroborate. The lithium chloride formed was filtered off, and the product was recrystallised from acetonitrile/methyl tert-butyl ether.

¹⁹F-NMR data for the anion correspond to those from Example 2.

### Example 4

### Tetraethylphosphonium trifluoromethyltrifluoroborate

Lithium trifluoromethyltrifluoroborate was reacted with tetraethylphosphonium chloride in acetonitrile at room temperature to give tetraethylphosphonium trifluoromethyltrifluoroborate. The lithium chloride formed was filtered off, and the product was recrystallised from acetonitrile/methyl tert-butyl ether.

¹⁹F-NMR data for the anion correspond to those from Example 2.

### Example 5

Preparation via Bu₃Sn[BF₃CF₃]

3.2 mmol (0.22 g) of boron trifluoride were condensed at −196° C. into 1.1 g (3.1 mmol) of trifluoromethyltri-n-butylstannane and 4 ml of carbon tetrachloride. The mixture was warmed to room temperature over the course of 10 minutes. After the solvent had been pumped out, 1.3 g of highly viscous Bu₃Sn⁺[BF₃CF₃]⁻ remained.

### Example 6

### Lithium trifluoromethyltrifluoroborate from Bu₃Sn⁺[BF₃CF₃]⁻ and LiF

1.3 g (3.1 mmol) of Bu₃Sn⁺[BF₃CF₃]^{-,} 0.08 g (3.1 mmol) of LiF and 30 ml of hot water were introduced into a round-bottomed flask fitted with a magnetic stirrer. The mixture was stirred for 12 hours, then heated at the boil for 1 hour. The precipitated fluorotributylstannane was filtered off. The water was removed from the solution which remained until the solution became viscous. For further isolation of Li⁺[B(CF₃)F₃]⁻, see above.

¹⁹F-NMR data for the anion correspond to those from Example 2.

¹⁹F-NMR [2]:−76.0 (q, ³J_{BF}=33.6 Hz);−156.0 (q, ¹J_{BF}=40.7 Hz). Data for anions correspond to those from ref. [1, 2].

### Example 7

### Lithium bis(trifluoromethyl)difluoroborate

600 ml of hot water were added to 78.0 g (182.7 mmol) of Bu₃Sn⁺[BF₃CF₃]⁻ and 7.1 g (274.1 mmol) of LiF, and the mixture was stirred for 12 hours and then heated at the boil for 1 hour. The precipitated fluorotributylstannane was filtered off, and the water was then removed until the solution was viscous.

150 ml of diethyl carbonate were then added to the viscous solution. Water was removed from the solution under a high vacuum (in this case, diethyl carbonate coordinates much better to lithium than water, which is why water can be removed first). A mixture of Li⁺BF₄⁻, Li⁺[BF₃CF₃]⁻, Li⁺[BF₂(CF₃)₂]⁻ was obtained. The solution was extracted a number of times with 4×30 ml of water and checked by ¹⁹F-NMR spectroscopy (Li+BF₄⁺ and Li⁺[BF₃CF₃]⁺) were present in the aqueous phase. The diethyl carbonate solution was dried using magnesium sulfate and filtered, 0.2 g of lithium carbonate was then added (in order to neutralise HF present), and the mixture was again filtered (LiCO₃ and LiF are virtually insoluble in diethyl carbonate). The pH was checked using indicator paper. The salt content was determined by integration with 1,1-bis(trifluoromethyl)perfluorocyclohexane (b.p. 120° C.). In the final step, the 1,1-bis(trifluoromethyl)perfluorocyclohexane was removed from the solution under a high vacuum. This gave a solution of 6.7 g of lithium bis(trifluoromethyl)difluoroborate in 22.8 g of diethyl carbonate.

¹⁹F-NMR data for the anion correspond to those from [2].

### Example 8

### Tetraethylammonium bis(trifluoromethyl)difluoroborate

Lithium bis(trifluoromethyl)difluoroborate was reacted with tetraethylammonium chloride in acetonitrile at room temperature to give tetraethylammonium bis(trifluoromethyl)difluoroborate. The lithium chloride formed was filtered off, and the product was recrystallised from acetonitrile/methyl tert-butyl ether.

¹⁹F-NMR data for the anion correspond to those from [2].

### Example 9

### Conductivity Studies

Table I: Specific Ionic Conductivities in EC:DMC (50:50 wt %) (T=25° C.)

| | Conductivity [mS cm⁻¹] | | | | |
|---|---|---|---|---|---|
| Concentration | Li[BF₃ | Li[BF₂ | Li[BF₃ | | |
| [mol/dm³] | (CF₃)] | (CF₃)₂] | (CH₃)] | LiBF₄ | LiPF₆ |
| 0.5 | 5.9 | | | | 6.4 |
| 0.75 | 6.5 | 7.2 | 3.3 | | |
| 1 | 6.1 | | 3.4 | 3.1 | 7.0 |
| 1.25 | 5.4 | | 3.3 | | 6.4 |

### Example 10

### Electrochemical Stability

In a measurement cell with platinum working electrode, lithium counterelectrode and lithium reference electrode, 3 cyclic voltamogrammes were recorded one after the other. To this end, the potential was increased from the rest potential to 6.0 V against Li/Li⁺ at a feed rate of 10 mV/s and then returned to the rest potential.

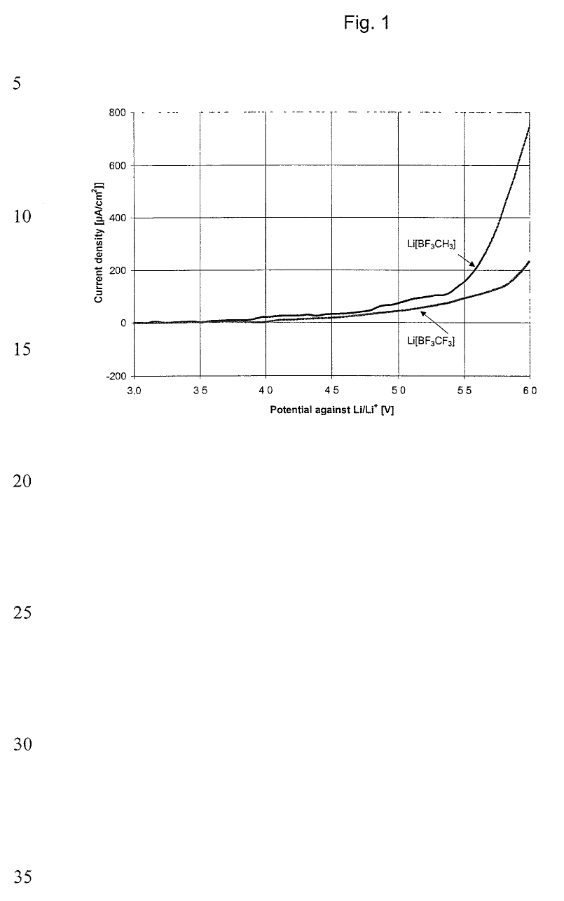

The electrolytes used were 0.5 molar solutions of Li[BF₃CH₃] and Li[BF₃CF₃] in EC/DEC (50:50 wt %). FIG. 1 shows the first half cycles of each of the cyclic voltamogrammes.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A borate salt of formula (I)
Mⁿ⁺[BFₓ(C_{y}F_{2y+1-z}H_{z})₄₋ₓ]ₙ⁻ (I)
in which:
1<x<3,
1≦y≦8,
0≦z≦2y+1,
1≦n≦3, and
M is a monovalent to trivalent cation or an aromatic heterocyclic cation, with the proviso that M is not potassium or barium.

2. A borate salt according to claim 1, wherein M is
Li, NR¹R²R³R⁴, PR⁵R⁶R⁷R⁸, P(NR⁵R⁶) ₖR⁷ₘR⁸₄₋ₖ₋ₘ, or
C(NR⁵R⁶)(NR⁷R⁸)(NR⁹R¹⁰),
k is 1 to 4,
M is 0 to 3,
k +m≦4,
R¹ to R⁴ are, each independently, C_{y}F_{2y+1-z}H_{z},
R⁵ to R¹⁰ are, each independently, H, C_{y}F_{2y+1-z}H_{z}, and
x, y and z are defined as in claim 1.

3. A borate salt according to claim 1, wherein the aromatic heterocyclic cation is a nitrogen, oxygen- and/or sulfur-containing aromatic heterocyclic cation.

4. An electrolyte comprising at least one compound of claim 1.

5. An electrolyte according to claim 4, further comprising at least one conductive salt or additive which is not a compound of formula (I).

6. An electrochemical cell comprising an electrolyte according to claim 4.

7. A battery, double layer capacitor or supercapacitor comprising an electrolyte according to claim 4.

8. A process for the preparation of a compound of claim 1, comprising:
a) reacting a BF₃-solvent complex 1:1 with alkyllithium while cooling, removing the majority of the solvent after slow warming, and filtering off and washing the resultant solid with a solvent, or
b) reacting a lithium salt 1:1 with B(CF₃)F₃ salt in a solvent, stirring the resultant mixture at elevated temperature, removing the solvent, adding an aprotic non-aqueous solvent to the mixture, and drying the mixture, or
c) reacting a B(CF₃)F₃ salt 1:1 to 1:1.5 with lithium salt in water at elevated temperature, boiling the resultant mixture 0.5 to 2 hours, removing the water, adding an aprotic non-aqueous solvent to the mixture, and drying the mixture.

9. A process according to claim 8, wherein the aprotic non-aqueous solvent is a solvent capable of use in electrochemical cells.
